(19) United States
(12) Patent Application Publication
(10) Pub. No.: US 2005/0248048 A1
(43) Pub. Date: Nov. 10, 2005

(54) Thermosetting resin injection molding method capable of reducing molding time

(75) Inventors: Makoto Suzuki, Kariya-city (JP); Takeshi Kusano, Nagoya-city (JP); Hiroshi Nagae, Toyohashi-city (JP); Yoshitaka Kamiya, Anjo-city (JP); Hisashi Kayano, Toyoake-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Aichi-pref. (JP)

(21) Appl. No.: 11/120,864

(22) Filed: May 3, 2005

(30) Foreign Application Priority Data
May 7, 2004 (JP) 2004-138580
Mar. 18, 2005 (JP) 2005-80489

(51) Int. Cl. B29C 45/78; B29C 45/73

(52) U.S. Cl. 264/40.6; 264/328.2; 264/328.16

(57) ABSTRACT

In a thermosetting resin injection molding method, a mold comprising at least two portions and heaters for heating and controlling the mold to a predetermined temperature is provided. The method comprises a mold closing steps for closing the mold to form a cavity, an injection step for injecting a thermosetting resin material into the cavity, a hardening step for hardening the thermosetting resin material, and a mold opening step for opening the mold for taking out a hardened and molded product. When one cycle consists of steps from the mold closing step to the mold opening step, a cooling step is included in which the temperature of a cavity forming surface is reduced during a period from the end of the hardening step to the start of the injection step, and mold temperature is controlled by the heaters to a predetermined temperature at all times through the cycle.

### BACKGROUND OF THE INVENTION

1. Field of the Invention

The present invention relates to a thermosetting resin injection molding method and, more particularly, to a thermosetting resin injection molding method capable of reducing a molding time (cycle time).

2. Description of the Related Art

Thermosetting resins include phenol resins, epoxy resins, etc. In comparison of the thermosetting resin with a thermoplastic resin, while a thermoplastic resin readily softens when heated after hardening because of a linear molecular structure, the thermosetting resin does not soften even when heated after hardening because of a three-dimensional reticulate structure, that is, the thermosetting resin has heat resistance. Further, while the thermoplastic resin solidifies when cooled, the thermosetting resin hardens when heated and, therefore, the molding methods for these resins differ from each other.

Because of the heat resistance, a thermosetting resin is widely used as a material for heat-resistant products, such as automobile parts, electric parts, or electronic parts. Methods for manufacturing thermosetting resin products include compression molding, transfer molding, injection molding, etc. The present invention relates to an injection molding, of a thermosetting resin, in which the hardening time is shortened and, therefore, the cycle time is also shortened by varying the temperature of the mold cavity surface during the molding process (molding cycle time). As in the case of a thermoplastic resin, in a process of a thermosetting resin injection molding, the process has steps in which a resin material is injected into a closed mold, the resin material is hardened, and the product is taken out by opening the mold. However, as described above, the way of hardening a thermosetting resin differs from that of a thermoplastic resin. An injection molding apparatus of a thermosetting resin has, for example, a structure capable of heating by having a heating cylinder, a heater inside a mold, etc.

Conventionally, when molding is carried out at a constant set temperature, in the hardening reaction of a thermosetting resin, it is not possible to shorten the hardening time beyond a certain limited time because of the need to prevent swelling caused by residual gas produced internally and held inside the molded product and, if the mold temperature is raised in order to promote hardening, a defect may be produced, causing the strength of a molded product to deteriorate.

On the other hand, as methods for controlling the mold temperature, a method in which a high-temperature gas is supplied (for example, refer to Patent document 1) and a method in which heat conduction and heat radiation are used (for example, refer to Patent document 2) have been proposed. However, they are not applicable because the varying pattern of temperature is targeted at a thermoplastic resin. In a method in which a temperature control plate and a temperature control block are used (for example, refer to Patent document 3), as the temperature of the entire mold is varied, it is not possible to obtain a target variation of temperature within a predetermined time. A method in which steam is used as a temperature control medium (for example, refer to Patent document 4) is not applicable because it is not possible to raise the temperature up to the hardening temperature of a thermosetting resin. In a device in which the temperature of a heating medium such as a heater is controlled and varied during the period of one cycle (for example, refer to Patent document 5), an intended temperature control cannot be carried out because a time lag occurs when heat is conducted from the heating medium to the cavity surface.
[Patent document 1] Japanese Unexamined Patent Publication (Kokai) 7-178783
[Patent document 2] Japanese Unexamined Patent Publication (Kokai) 9-104048
[Patent document 3] Japanese Unexamined Patent Publication (Kokai) 10-315292
[Patent document 4] Japanese Unexamined Patent Publication (Kokai) 11-348041
[Patent document 5] Japanese Unexamined Patent Publication (Kokai) 62 -16533

### SUMMARY OF THE INVENTION

The above-mentioned circumstances being taken into account, the present invention has been developed and the object thereof is to provide a method for shortening the hardening time of a thermosetting resin by varying the mold temperature during the molding cycle and, particularly, by raising the mold temperature during the period of the latter half of the hardening time in the case where it is not possible to shorten the hardening time because of the swelling produced when a thermosetting resin is molded.

In order to attain the above-mentioned object, in an injection molding method of a thermosetting resin according to a first aspect of the present invention, a mold comprising at least two portions and heaters provided inside the mold for heating and controlling the mold to a predetermined temperature is provided. The injection molding method comprises: a mold closing step for closing the mold to form a cavity; an injection step for injecting a thermosetting resin material into the cavity; a hardening step for hardening the thermosetting resin material injected into the cavity; and a mold opening step for opening the mold to take out a hardened and molded product. If it is assumed that one cycle consists of steps from the mold closing step to the mold opening step, the injection molding method is characterized in that it comprises a cooling step in which a temperature of a cavity forming surface of the cavity is reduced during a period of time from an end of the hardening step to a start of the injection step in a next cycle and in that the heaters are controlled to predetermined temperatures through the cycle.

Due to the above-mentioned structure, it becomes possible to gradually raise the temperature of the cavity forming surface by transferring heat stored inside the mold and, therefore, to shorten the hardening time, without deteriorating the strength of a molded product in a thermosetting resin injection molding process by cooling the cavity surface before the injection step while controlling the temperature of the mold throughout the cycle using the heaters.

A second aspect of the present invention is characterized in that a temperature variation pattern of the cavity forming surface is realized by controlling the temperature of the mold to a constant set temperature, in the first aspect described above.

According to the present aspect, the control of the mold temperature can be carried out more easily.

A third aspect of the present invention is characterized in that at least a thermocouple for measuring temperatures used to control the heaters and at least a thermocouple for measuring the temperature in the vicinity of the mold cavity are provided inside the mold, in the first or second aspect described above.

According to the present aspect, a mold structure able to carry out the present invention is realized and, further, an injection molding method is realized.

A fourth aspect of the present invention is characterized in that cooling of the cavity forming surface is carried out by spraying a low-temperature liquid or gas onto the cavity forming surface in the cooling step which is provided in a period including the mold opening step and the mold closing step and, while the mold is open, in any one of the first to third aspects described above.

According to the present aspect, an aspect in which the present invention is more effective is embodied.

A fifth aspect of the present invention is characterized in that the cooling of the cavity forming surface in the cooling step is carried out by using a mixed gas of air and mist in any one of the first to fourth aspects described above.

According to the present aspect, it is possible to quickly carry out the cooling of the cavity forming surface, thereby leading to the reduction in the cycle time in the injection molding method.

A sixth aspect of the present invention is characterized in that the thermosetting resin produces a gas in a hardening reaction process, in any one of the first to fifth aspects described above.

According to the present aspect, the properties of a thermosetting resin material with which the present invention is more effective are defined.

A seventh aspect of the present invention is characterized in that the thermosetting resin is a phenol resin in any one of the first to sixth aspects described above.

According to the present aspect, the thermosetting resin material that is the target of the present invention is embodied in a more concrete manner.

An eighth aspect of the present invention is characterized in that the normal molding temperature of the thermosetting resin is 170 to 190° C. in any one of the first to seventh aspects described above.

According to the present aspect, the molding temperature as well as the thermosetting resin material that is the target of the present invention is embodied in a more concrete manner.

The present invention may be more fully understood from the description of the preferred embodiments of the invention set forth below, together with the accompanying drawings.

### BRIEF DESCRIPTION OF THE DRAWINGS

In the drawings:

FIG. 1 is a diagrammatic sectional side elevation of a mold of an injection molding apparatus capable of carrying out an injection molding method of a thermosetting resin according to a preferred embodiment of the present invention.

FIG. 2 is a graph showing the changes of a control set temperature Th of a mold and a cavity forming surface temperature Ts of a preferably-controlled mold in each step of an injection molding method according to a preferred embodiment of the present embodiment.

FIG. 3 is a diagrammatic illustration of spraying of air and mist and a state in which heat is transferred from a mold to the air and mist in the embodiment.

FIG. 4 is a graph showing the changes over time of surface temperatures Ts (when the cavity is filled with the resin and when empty) of the cavity forming surface of the mold and a mold set temperature Th during the period of one cycle in an actual experiment of the present invention.

FIG. 5 shows a comparison, between the present invention and a prior art, of the change in viscosity of a phenol resin, that is, a thermosetting resin, in an injection molding process during the period of one cycle in the embodiment.

FIG. 6 is a diagrammatic sectional side elevation of a second embodiment of a mold of an injection molding apparatus capable of carrying out a thermosetting resin injection molding method according to the present invention.

### DESCRIPTION OF THE PREFERRED EMBODIMENTS

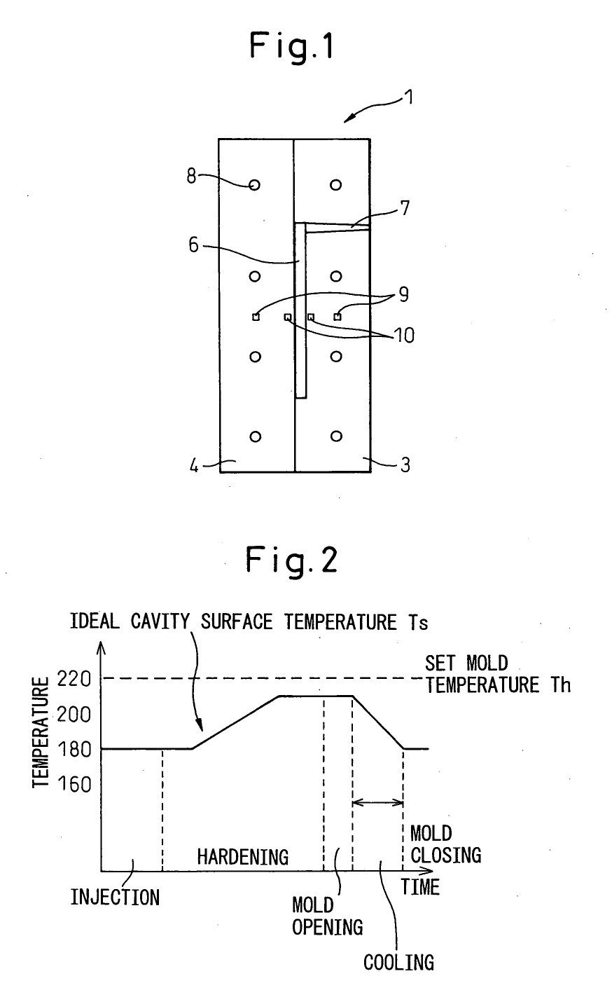

An injection method in an embodiment of the present invention is explained in detail below with reference to drawings. FIG. 1 is a diagrammatical sectional side elevation of a mold of an injection molding apparatus capable of carrying out an injection molding method of a thermosetting resin according to a preferred embodiment of the present invention.

FIG. 1 shows a mold 1 of an injection molding apparatus according to a preferred embodiment of the present invention, the mold 1 comprising a fixed mold 3 and a movable mold 4. In FIG. 1, the movable mold 4 is assembled with the fixed mold 3, the mold 1 is closed, and a cavity 6 is formed between the fixed mold 3 and the movable mold 4 (a mold closing step). The cavity 6 has, for example, a plate-like shape as shown in FIG. 1. In this state, a thermosetting resin material, that is, a phenol resin in the present embodiment, is supplied to the cavity 6 inside the mold 1 through a runner 7 from an injection molding apparatus, not shown (an injection step). Heaters 8 (eight heaters are provided in the present embodiment, four to the movable mold 4 and four to the fixed mold 3, respectively, however, the number of heaters may be greater or less) provided inside the mold 1 are controlled by a temperature control device, not shown here, which controls the temperature to be measured by first thermocouples 9 (two thermocouples are provided in the present embodiment, one to the movable mold 4 and one to the fixed mold 3, respectively, however, the number of thermocouples may be greater or less) provided inside the mold 1 to a predetermined set temperature. Second thermocouples 10 (two thermocouples are provided in the present embodiment, as in the case of the first thermocouple 9) are provided inside the mold 1 and a cavity surface temperature Ts is measured by the second thermocouple 10.

After the above-mentioned mold closing step and injection step, the injected thermosetting resin material is hardened into a product shape by transferring thereto the heat of the mold 1 controlled in temperature by the heaters 8 provided inside the mold 1 (a hardening step). After the thermosetting resin material hardens, the mold is opened and the molded product is taken out (a mold opening step). Then, the mold is closed in the mold closing step and the same process is repeated. One cycle of the injection molding method of a thermosetting resin material in the present embodiment includes steps from the above-mentioned mold closing step to the mold opening step. By repeating the cycle, the products are molded one after another.

In the present embodiment, a cooling step is carried out between the mold opening step and the mold closing step in the molding cycle in which the procedure proceeds from the injection step to the hardening step, the mold opening step, and the mold closing step.

FIG. 2 shows the set temperature of the mold and an ideal cavity surface temperature Ts for molding a product without defects in a short cycle period, in each step.

In the present embodiment, when a phenol resin is molded in a short cycle period without defects, the temperature inside the mold 1 (the movable mold 4 and fixed mold 3) is controlled through a cycle to a constant temperature, for example, a predetermined temperature Th between 200 and 240° C. (220° C., in the present embodiment), which is higher than the normal set temperature Tu (160 to 190° C.) at which a case without the use of the present invention is carried out.

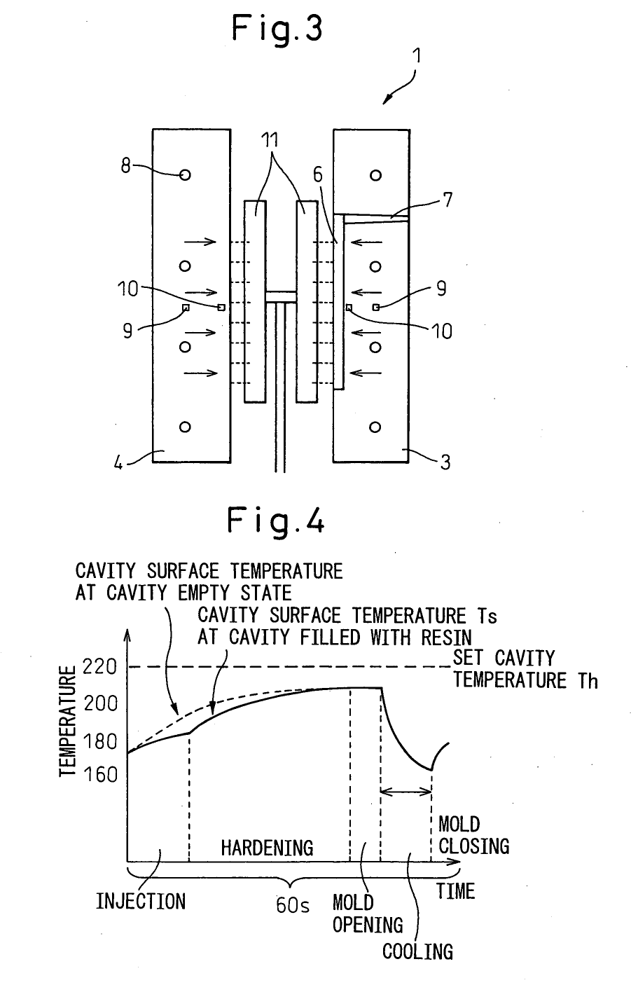

In a state in which the mold 1 is controlled to a constant temperature by the heaters 8, in the mold opening step, the cavity forming surfaces of the fixed mold 3 and the movable mold 4 are sprayed with air and mist including water mist the temperature of which is sufficiently lower than the temperature of the mold 1 and, thereby, the cavity forming surfaces are cooled. Due to this, the temperature of the cavity forming surface is reduced to a temperature, for example, about 160° C. lower than the set temperature Th of the heaters 8. The above-mentioned spraying of air and mist is carried out by spraying air and mist at a high speed from a nozzle 11 provided with a plurality of small holes. The spraying of air and mist, and how heat is transferred from the mold 1 to the air mist, are shown diagrammatically in FIG. 3. Although the cavity surface temperature Ts is reduced temporarily by the spraying of air mist, the temperature inside the mold is controlled to the predetermined temperature Th and the heat stored inside the mold is transferred to the cavity surface after the spraying of air mist is completed and, therefore, the cavity surface temperature gradually rises during the period of time between the injection step and the hardening step. Conventionally, deburring is carried out in the period of the cooling step and, therefore, if the spraying of air mist is carried out during the period of the mold opening step, it is unlikely that the molding cycle time is lengthened.

FIG. 4 shows the changes over time of the surface temperature Ts (measured by the second thermocouple 10) of the cavity forming surface of the mold 1 and the temperature Tc inside the mold 1 to be measured by the first thermocouple 9 in one cycle in the actual experiment. In the experiment in which the present invention is actually carried out, the level of cooling the cavity forming surfaces by air and mist is controlled so that the temperature Ts of the cavity forming surface changes over time as shown in FIG. 4. In FIG. 4, the dotted line shows a case where the cavity 6 is empty and the solid line shows a case where the phenol resin is injected and the cavity is filled therewith. By cooling the cavity, the surface temperature Ts of the cavity forming surface of the mold 1 is reduced to a temperature below, for example, 160° C., which is the initial temperature. However, when the cooling is stopped and the mold is closed for injection molding, the heat stored in the mold 1 is transferred to the cavity forming surface and the flow rate of air mixed with mist to be sprayed and the time for spraying thereof are adjusted so that the surface temperature Ts of the cavity forming surface is raised to, for example, a temperature of 180° C. After this, the surface temperature Ts of the cavity forming surface rises by the heat transferred from the inside of the mold during the period of time including the injection step and the hardening step after the mold is closed, reaching 200° C. in the latter half of the hardening step. As the temperature Tc inside the mold is controlled to 220° C. (and coincides with the set temperature Th of the mold) by the temperature control device and the heaters 8, therefore, the temperature Tc is constant through one molding cycle. Due to this, it is possible to carry out injection molding with a molding cycle of 60 seconds by using the present invention while it took 75 seconds for one cycle molding when injection molding was carried out using the mold controlled to a constant temperature of the normal set temperature Tu without the use of the present invention.

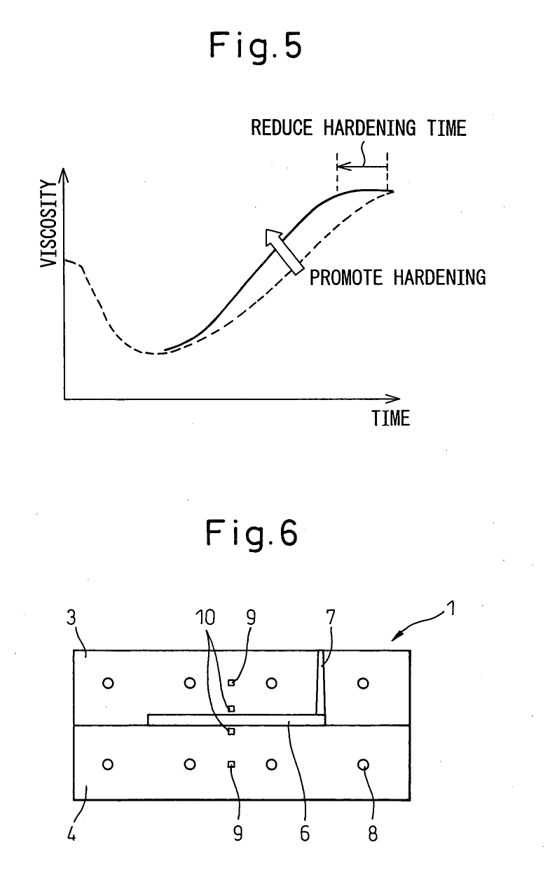

The change in viscosity of the phenol resin, that is, the thermosetting resin in the injection molding process in one cycle in the present embodiment described above is shown by the solid line in FIG. 5. In FIG. 5, an example of a conventional injection molding is shown by the dotted line and it is apparent that the hardening time is shorter in the present embodiment.

Next, the effect and function of the present embodiment described above are explained below.

The following effect can be expected from the injection molding method of a thermosetting resin in the preferred embodiment of the present invention.

In a thermosetting resin injection molding process, the hardening time can be shortened without the occurrence of defects such as swell and void. The cooling of the cavity forming surface of the mold 1 is carried out in the mold opening step, it is unlikely that the cycle time is lengthened because deburring is carried out conventionally during the period of the mold opening step.

In the above explanation, the thermosetting resin in the present invention is described as a phenol resin, however, the resin may be a thermosetting resin other than the above such as an epoxy resin. Further, the temperature set in the injection molding process, as described above or in the embodiment shown in the accompanying drawings, is merely an example and may be set otherwise in accordance with the thermosetting resin or the product to be molded.

In the above explanation, the present embodiment is carried out using the mold that is opened along a horizontal line as shown in FIG. 1, but it is also possible to use a mold that is opened along a vertical line as shown in FIG. 6.

In the above embodiment, the set temperature Th of the mold 1 is controlled by the heaters 8 to a constant temperature at all times but the set temperature Th does not need to be constant at all times as long as the set temperature Th is in a range in which the variation pattern of the above-mentioned cavity surface temperature can be realized.

The above embodiment is merely an example of the present invention and the present invention is not limited by the embodiment, but defined only by the claims set forth below and embodiments other than the above embodiment are also possible.

1. An injection molding method of a thermosetting resin comprising the steps of:
a mold closing step for closing a mold, comprising at least two portions and heaters for heating and controlling the mold to a predetermined temperature, so as to form a cavity;
an injection step for injecting a thermosetting resin material into the cavity;
a hardening step for hardening the thermosetting resin material injected into the cavity; and
a mold opening step for opening the mold for taking out a hardened and molded product, wherein:
a cooling step is further included, in which, if one cycle consists of steps from the mold closing step to the mold opening step, temperature of a cavity forming surface is reduced during a period of time from an end of the hardening step to a start of the injection step in a next cycle; and
the heaters are controlled to a predetermined temperature through the cycle.

2. The injection molding method as set forth in claim 1, wherein the predetermined temperature to which the heaters are controlled is constant through the cycle.

3. The injection molding method as set forth in claim 1, wherein at least a thermocouple for measuring temperature used to control the heaters and at least a thermocouple for measuring temperature in the vicinity of the cavity of the mold are provided inside the mold.

4. The injection molding method as set forth in claim 1, wherein cooling of the cavity forming surface in the cooling step is carried out by spraying a low-temperature liquid or gas onto the cavity forming surface during a period including the mold opening step and the mold closing step, and while the mold is open.

5. The injection molding method as set forth in claim 1, wherein cooling of the cavity forming surface in the cooling step is carried out by using a mixed gas of air and mist.

6. The injection molding method as set forth in claim 1, wherein the thermosetting resin produces a gas in hardening reaction.

7. The injection molding method as set forth in claim 1, wherein the thermosetting resin is a phenol resin.

8. The injection molding method as set forth in claim 1, wherein a normal molding temperature of the thermosetting resin is 170 to 190° C.
